(19) United States
(12) Patent Application Publication
(10) Pub. No.: US 2026/0341856 A1
(43) Pub. Date: Oct. 29, 2026

(54) SECONDARY BATTERY AND ELECTRICAL DEVICE

(71) Applicant: Ningde Amperex Technology Limited, Ningde (CN)

(72) Inventors: Qiaofeng CHEN, Ningde (CN); Guowen ZHANG, Ningde (CN); Jiaxu YU, Ningde (CN)

(73) Assignee: Ningde Amperex Technology Limited, Ningde (CN)

(21) Appl. No.: 19/658,749

(22) Filed: Apr. 27, 2026

(30) Foreign Application Priority Data
Apr. 27, 2025 (CN) 202510541112.6

(51) Int. Cl. H01M 50/145; H01M 50/119; H01M 50/124; H01M 50/128; H01M 50/134; H01M 50/184; H01M 50/186; H01M 50/534; H01M 50/54

(52) U.S. Cl. CPC H01M 50/145; H01M 50/119; H01M 50/1243; H01M 50/128; H01M 50/134; H01M 50/184; H01M 50/186; H01M 50/534; H01M 50/54

(57) ABSTRACT

A secondary battery includes a casing, an electrode assembly disposed in the casing, and a sealing element configured to seal the casing. The casing includes a first casing and a second casing that are insulated and that jointly form an accommodation cavity. The accommodation cavity is filled with an electrolyte solution. The first casing and the second casing are disposed facing each other, with a clearance in between. The first casing includes a first metal layer and a second metal layer that covers a surface of the first metal layer, the surface being away from the accommodation cavity. Hardness of both the second casing and the second metal layer is greater than hardness of the first metal layer. A positive electrode of the electrode assembly is electrically connected to the first metal layer. A negative electrode of the electrode assembly is electrically connected to the second casing.

### CROSS-REFERENCE TO RELATED APPLICATION

This application claims priority to the Chinese Patent Application Serial No. 202510541112.6, filed on Apr. 27, 2025, the content of which is incorporated herein by reference in its entirety.

### TECHNICAL FIELD

This application relates to the technical field of energy storage, and in particular, to a secondary battery and an electrical device.

### BACKGROUND

Currently, secondary batteries include steel-cased batteries and pouch batteries. Generally, a steel-cased battery and a pouch battery each include a casing and an electrode assembly accommodated in the casing. The casing of a steel-cased battery includes a first casing and a second casing. The first casing and the second casing are hermetically connected by welding or by a sealing element.

### SUMMARY

In a secondary battery in the prior art, if a first casing is electrically connected to a positive electrode of an electrode assembly and a second casing is electrically connected to a negative electrode of the electrode assembly, then the first casing and the second casing are not suitable for being hermetically connected by welding, but are suitable for being hermetically connected by a sealing element. To address this situation, the applicant hereof discovers that because a positive electrode plate and a negative electrode plate of the electrode assembly are made of different metals, in order to reduce a potential difference between the positive electrode and the first casing and a potential difference between the negative electrode and the second casing, and to reduce the probability of electrochemical corrosion of the casing, the first casing is typically made of a metal similar to the material of the positive electrode plate and the second casing is typically made of a metal similar to the material of the negative electrode plate. However, different metals exhibit different strength. Compared to the second casing that is typically made of stainless steel, the first casing electrically connected to the positive electrode is typically made of aluminum alloy. With a typical thickness, aluminum alloy is weaker than stainless steel in strength (to achieve strength similar to that of stainless steel, the thickness of aluminum alloy needs to exceed at least 150 μm). When subjected to impact, the first casing is prone to be worn or even cracked, leading to a risk of leakage in the secondary battery.

In view of the above situation, it is necessary to provide a secondary battery that can reduce the potential difference between the positive electrode and the first casing and reduce the probability of electrochemical corrosion of the first casing while increasing the strength of the first casing and reducing the risk of leakage of the secondary battery.

According to a first aspect of this application, a secondary battery is provided, including a casing, an electrode assembly, and a sealing element. The casing includes a first casing and a second casing that are insulated from each other. The first casing and the second casing together form an accommodation cavity. The accommodation cavity is filled with an electrolyte solution. The first casing and the second casing are disposed facing each other, with a clearance in between. The first casing includes a first metal layer and a second metal layer. The second metal layer covers a surface of the first metal layer, the surface of the first metal layer being facing away from the accommodation cavity. A hardness of both the second casing and a hardness of the second metal layer are greater than a hardness of the first metal layer. The electrode assembly is disposed in the accommodation cavity. A positive electrode of the electrode assembly is electrically connected to the first metal layer. A negative electrode of the electrode assembly is electrically connected to the second casing. The sealing element is disposed around an outer periphery of the first casing and the second casing, and is configured to seal the clearance.

The first metal layer is electrically connected to the positive electrode of the electrode assembly, and therefore, the first metal layer can be made of a metal similar to the material of the positive electrode of the electrode assembly, thereby reducing the potential difference between the positive electrode and the first casing, and reducing the probability of electrochemical corrosion of the first casing. The second metal layer covers the surface, away from the accommodation cavity, of the first metal layer, and the hardness of the second metal layer is greater than that of the first metal layer, thereby increasing the overall hardness of the first casing. When the first casing is impacted, the harder second metal layer is impacted first, thereby reducing the risk of leakage in the secondary battery caused by cracking of the first casing.

In one or more embodiments, the first metal layer is made of a material including at least one of aluminum, zinc, or magnesium; and the second casing and the second metal layer each are made of a material including at least one of iron, nickel, chromium, or titanium. This reduces the potential difference between the positive electrode and the first metal layer, and increases the hardness of the second casing and the second metal layer.

In one or more embodiments, the electrode assembly includes a positive electrode plate. The positive electrode plate includes a positive current collector and a positive active material layer. The positive active material layer is disposed on two surfaces of the positive current collector, the two surfaces being opposite to each other along a thickness direction of the current collector. The positive current collector is provided with a positive tab. The positive current collector and the first metal layer are electrically connected to the positive tab. Both the positive tab and the positive current collector are made of aluminum foil. The first metal layer is made of a material including aluminum. This further reduces the potential difference between the first casing and the positive electrode of the electrode assembly, and further reduces the probability of electrochemical corrosion of the first casing.

In one or more embodiments, along a wall thickness direction of the first casing, a thickness of the first metal layer is H₁, and a thickness of the second metal layer is H₂, wherein 16 μm≤H₁+H₂≤150 μm, H₁≥6 μm, and H₂≥10 μm. By setting H₁≥6 μm, this application prevents the first metal layer from being excessively thin, thereby reducing the risk that the first metal layer is burned through when the first metal layer is connected by welding. By setting H₂≥10 μm, this application prevents the second metal layer from being excessively thin, thereby improving the impact resistance of the second metal layer. By setting H₁+H₂≤150 μm, this application prevents the first casing from being excessively thick, thereby reducing the loss of energy density of the secondary battery.

In one or more embodiments, 23 μm≤H₁+H₂≤120 μm, H₁≥8 μm, and H₂≥15 μm. By setting H₁≥8 μm, this application further reduces the risk of the first metal layer being burned through during welding. By setting H₂≥15 μm, this application further improves the impact resistance of the second metal layer. By setting H₁+H₂≤120 μm, this application further reduces the loss of energy density of the secondary battery.

In one or more embodiments, the first metal layer includes a first wall and a first sidewall connected to the periphery of the first wall. The second metal layer includes a second wall and a second sidewall connected to the periphery of the second wall. The second casing includes a third wall and a third sidewall connected to the periphery of the third wall. The first wall and the second wall are disposed facing the third wall. The first sidewall and the second sidewall are disposed facing the third sidewall along a thickness direction of the electrode assembly and at a clearance from the third sidewall. The sealing element includes a filler portion filling the clearance. The filler portion that fills the clearance increases sealing interfaces between the sealing element and the first and the second casings, and improves hermeticity of the secondary battery. Further, the filler portion that fills the clearance also facilitates insulation of the first casing and the second casing.

In one or more embodiments, the filler portion covers at least a surface of the second sidewall, the surface facing the clearance. When the second metal layer is made of a relatively hard metal and the first metal layer is made of a less hard metal, the second metal layer and the first metal layer are made of different metal materials. By leaving the filler portion to cover the clearance-facing surface of the second sidewall, this application reduces the probability of electrochemical corrosion of the first casing caused by a potential difference generated when the first metal layer and the second metal layer are in simultaneous contact with the electrolyte solution.

In one or more embodiments, a protective layer is provided on a surface of the first sidewall facing the clearance and on the surface of the second sidewall facing the clearance. The filler portion is disposed between the third sidewall and the protective layer. The protective layer is made of a material including at least one of polytetrafluoroethylene, polyvinylidene fluoride, epoxy resin, aluminum oxide, zirconium oxide, or silicone. By making the protective layer include the above material and disposing the protective layer on the clearance-facing surfaces of the first sidewall and the second sidewall, this application reduces the probability that the electrolyte solution erodes the sealing interface between the filler portion and the first and second metal layers. This further reduces the probability of electrochemical corrosion of the first casing caused by a potential difference generated when the first metal layer and the second metal layer are in simultaneous contact with the electrolyte solution.

In one or more embodiments, the first metal layer includes an extension portion. The extension portion is disposed at an end portion of the first sidewall, the end portion of the first sidewall facing the clearance. The filler portion is disposed between the third sidewall and the extension portion. The extension portion covers a surface of the second sidewall, the surface facing the clearance. By leaving the extension portion of the first metal layer to cover the clearance-facing surface of the second sidewall, this application causes the sealing interface between the extension portion and the filler portion to become a sealing interface between the first casing and the filler portion. This conveniently gives rise to a smoother sealing interface between the first casing and the filler portion, makes the sealing interface less prone to electrolyte corrosion, and improves the hermeticity of the secondary battery. In addition, the extension portion can effectively isolate the clearance-facing surface of the second sidewall from the electrolyte solution, and reduce the probability of electrochemical corrosion of the first casing caused by a potential difference generated when the first metal layer and the second metal layer are in simultaneous contact with the electrolyte solution.

In one or more embodiments, Brinell hardness of the first metal layer is 10 HB to 60 HB, Brinell hardness of the second casing is 110 HB to 320 HB, and Brinell hardness of the second metal layer is 110 HB to 320 HB. Without making the hardness excessively low, this arrangement makes it convenient to prepare the first metal layer, the second metal layer, and the second casing of the desired hardness using common metal materials.

In one or more embodiments, yield strength of the second metal layer is greater than or equal to 150 MPa. Higher yield strength of the second metal layer improves the deformation resistance of the first casing under impact.

A second aspect of this application provides an electrical device. The electrical device includes the secondary battery disclosed in the first aspect of this application. The electrolyte solution in the secondary battery is not prone to leakage, thereby prolonging the lifespan of the electrical device.

### BRIEF DESCRIPTION OF DRAWINGS

FIG. 1 is a top view of a secondary battery according to an embodiment of this application;

FIG. 2 is a front view of a secondary battery according to an embodiment of this application;

FIG. 3 is an exploded view of a secondary battery according to an embodiment of this application;

FIG. 4 is a cross-sectional view taken along a section line A-A shown in FIG. 1 according to a first embodiment of this application;

FIG. 5 is a cross-sectional view taken along a section line A-A shown in FIG. 1 according to a second embodiment of this application;

FIG. 6 is a cross-sectional view taken along a section line A-A shown in FIG. 1 according to a third embodiment of this application; and

FIG. 7 is an overall schematic diagram of an electrical device according to an embodiment of this application.

List of reference signs:

1000 electrical device; 100 secondary battery; 10 casing; 101 accommodation cavity; 11 first casing; 111 first metal layer; 1111 first wall; 1112 first sidewall; 1113 extension portion; 112 second metal layer; 1121 second wall; 1122 second sidewall; 12 second casing; 121 third wall; 122 third sidewall; 20 electrode assembly; 21 positive electrode plate; 22 negative electrode plate; 23 separator; 30 sealing element; 301 filler portion; 31 first adhesive layer; 32 water-blocking layer; 33 second adhesive layer; 40 positive tab; 50 negative tab; 60 protective layer; 70 fixing piece.

### DETAILED DESCRIPTION

The following describes the technical solutions in some embodiments of this application with reference to the drawings hereof. Evidently, the described embodiments are merely a part of but not all of the embodiments of this application.

It is noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise expressly specified, the term “a plurality of” used herein means two or more.

The technical terms “first” and “second” are merely intended to distinguish between different items but not intended to indicate or imply relative importance or implicitly specify the number of the indicated technical features, specific order, or order of precedence.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein includes any and all combinations of one or more relevant items enumerated.

Understandably, in technical solutions of this application, considering the actual process tolerance, when two components are arranged parallel or perpendicular to each other, an angle may exist between the two components, and a measured value of this angle permits a tolerance of ±10% compared to the nominal value of the corresponding angle formed when the two components are arranged parallel or perpendicular. In the technical solutions of this application, when two parameters are equal, a tolerance of ±10% is allowed between the two parameters.

An embodiment of this application provides a secondary battery. The secondary battery includes a casing, an electrode assembly, and a sealing element. The casing includes a first casing and a second casing that are insulated from each other. The first casing and the second casing together form an accommodation cavity. The accommodation cavity is filled with an electrolyte solution. The first casing and the second casing are disposed facing each other, with a clearance in between. The first casing includes a first metal layer and a second metal layer. The second metal layer covers a surface of the first metal layer, the surface of the first metal layer being facing away from the accommodation cavity. A hardness of both the second casing and a hardness of the second metal layer are greater than a hardness of the first metal layer. The electrode assembly is disposed in the accommodation cavity. A positive electrode of the electrode assembly is electrically connected to the first metal layer. A negative electrode of the electrode assembly is electrically connected to the second casing. The sealing element is disposed around an outer periphery of the first casing and the second casing, and is configured to seal the clearance.

In the secondary battery of this application, the first metal layer is electrically connected to the positive electrode of the electrode assembly, and therefore, the first metal layer can be made of a metal similar to the material of the positive electrode of the electrode assembly, thereby reducing the potential difference between the positive electrode and the first casing, and reducing the probability of electrochemical corrosion of the first casing. The second metal layer covers the surface, away from the accommodation cavity, of the first metal layer, and the hardness of the second metal layer is greater than that of the first metal layer, thereby increasing the overall hardness of the first casing. When the first casing is impacted, the harder second metal layer is impacted first, thereby reducing the risk of leakage in the secondary battery caused by cracking of the first casing.

The following describes some embodiments of this application with reference to drawings. To the extent that no conflict occurs, the following embodiments and the features in the embodiments may be combined with each other.

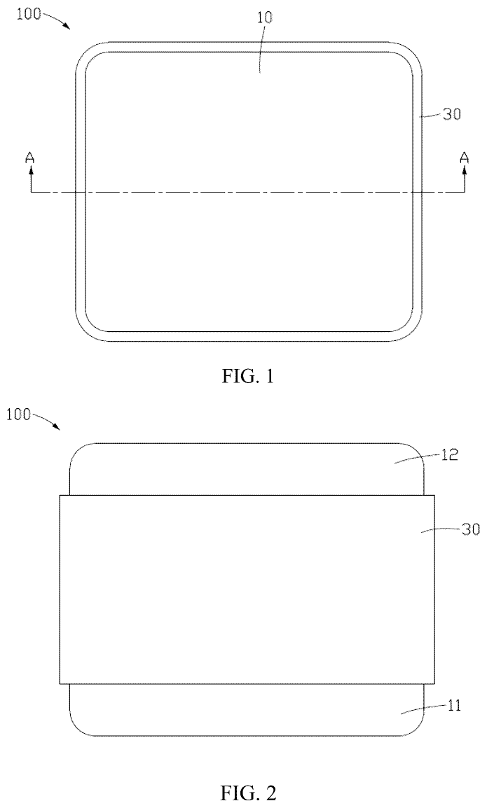

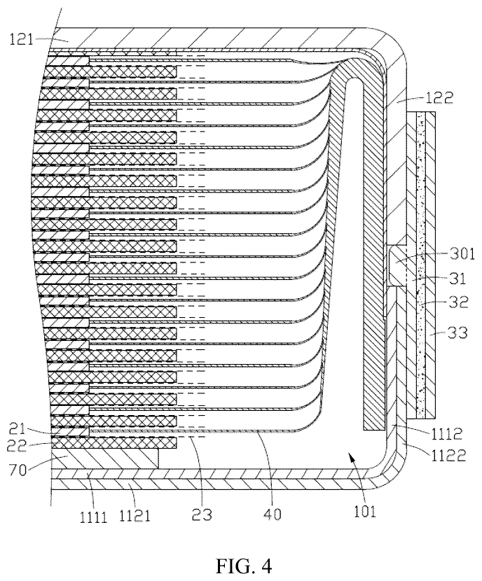

Referring to FIG. 1 to FIG. 3, an embodiment of this application provides a secondary battery 100. The secondary battery includes a casing 10, an electrode assembly 20, and a sealing element 30. The casing 10 includes a first casing 11 and a second casing 12 that are insulated from each other. The first casing 11 and the second casing 12 are disposed facing each other, with a clearance in between. The first casing 11 and the second casing 12 together form an accommodation cavity 101 (referring to FIG. 4). The accommodation cavity 101 is filled with an electrolyte solution. The electrode assembly 20 is disposed in the accommodation cavity 101. The sealing element 30 is disposed around the outer periphery of the first casing 11 and the second casing 12, and is configured to seal the clearance.

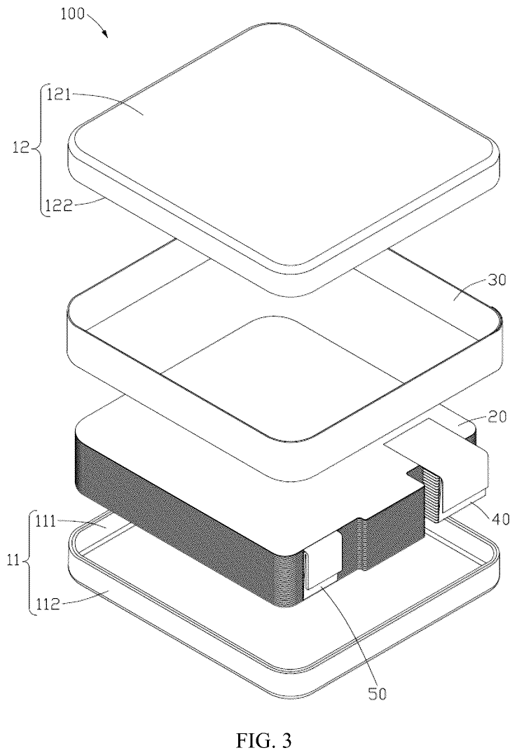

The casing 10 is a metal casing. Referring to FIG. 3, the first casing 11 includes a first metal layer 111 and a second metal layer 112. The second metal layer 112 covers a surface of the first metal layer 111, the surface of the first metal layer 111 being facing away from the accommodation cavity 101. A positive electrode of the electrode assembly 20 is electrically connected to the first metal layer 111. A negative electrode of the electrode assembly 20 is electrically connected to the second casing 12. Understandably, because the second metal layer 112 covers the surface, away from the accommodation cavity 101, of the first metal layer 111, the positive electrode of the electrode assembly 20 is likewise electrically connected to the second metal layer 112. By preparing the first metal layer 111 from a metal similar to the material of the positive electrode of the electrode assembly 20, this application reduces the potential difference between the positive electrode and the first casing 11, and reduces the probability of electrochemical corrosion of the first casing 11.

In some embodiments, the hardness of the second metal layer 112 is greater than that of the first metal layer 111, thereby increasing the overall hardness of the first casing 11. When the first casing 11 is impacted, the harder second metal layer 112 that covers the outer periphery of the first metal layer 111 is impacted first, thereby reducing the risk of leakage in the secondary battery 100 caused by cracking of the first casing 11. In some embodiments, the hardness of the second casing 12 is greater than that of the first metal layer 111.

In some embodiments, the Brinell hardness of the first metal layer 111 is 10 HB to 60 HB. For example, the Brinell hardness of the first metal layer 111 is 10 HB, 20 HB, 30 HB, 40 HB, 50 HB, 60 HB, or any value falling within a range formed by any two thereof. The Brinell hardness of the second metal layer 112 is 110 HB to 320 HB. For example, the Brinell hardness of the second metal layer 112 is 110 HB, 150 HB, 200 HB, 250 HB, 320 HB, or any value falling within a range formed by any two thereof. The Brinell hardness of the second casing 12 is 110 HB to 320 HB. For example, the Brinell hardness of the second casing 12 is 110 HB, 150 HB, 200 HB, 250 HB, 320 HB, or any value falling within a range formed by any two thereof. Without making the hardness excessively low, this arrangement makes it convenient to prepare the first metal layer 111, the second metal layer 112, and the second casing 12 of the desired hardness using common metal materials.

In some embodiments, the first metal layer 111 is made of a material including at least one of aluminum, zinc, or magnesium; the second metal layer 112 is made of a material including at least one of iron, nickel, chromium, or titanium; and the second casing 12 is made of a material including at least one of iron, nickel, chromium, or titanium.

In some embodiments, yield strength of the second metal layer 112 is greater than or equal to 150 MPa. For example, the yield strength of the second metal layer 112 is 150 MPa, 200 MPa, 250 MPa, 300 MPa, or any other achievable yield strength value. Higher yield strength of the second metal layer 112 improves the deformation resistance of the first casing 11 under impact.

In some embodiments, along the wall thickness direction of the first casing 11, the thickness of the first metal layer 111 is H₁, and the thickness of the second metal layer 112 is H₂, wherein 16 μm≤H₁+H₂≤150 μm, H₁≥6 μm, and H₂≥10 μm. It is easy to derive H₁≤140 μm and H₂≤144 μm. For example, the value of H₁+H₂ is 16 μm, 23 μm, 30 μm, 50 μm, 120 μm, 150 μm, or a value falling within a range formed by any two thereof. The value of H₁ is 6 μm, 8 μm, 30 μm, 50 μm, 105 μm, 140 μm, or a value falling within a range formed by any two thereof. The value of H₂ is 10 μm, 15 μm, 30 μm, 50 μm, 112 μm, 144 μm, or a value falling within a range formed by any two thereof. Limited by H₁+H₂≤150 μm, H₁ and H₂ do not simultaneously take their maximum values. By setting H₁≥6 μm, this application prevents the first metal layer 111 from being excessively thin, thereby reducing the risk that the first metal layer 111 is burned through when the first metal layer 111 is connected by welding. By setting H₂≥10 μm, this application prevents the second metal layer 112 from being excessively thin, thereby improving the impact resistance of the second metal layer 112. By setting H₁+H₂≤150 μm, this application prevents the first casing 11 from being excessively thick, thereby reducing the loss of energy density of the secondary battery 100.

In some embodiments, 23 μm≤H₁+H₂≤120 μm, H₁≥8 μm, and H₂≥15 μm. Limited by H₁+H₂≤120 μm, H₁ and H₂ do not simultaneously take their maximum values. By setting H₁≥8 μm, this application further reduces the risk of the first metal layer 111 being burned through during welding. By setting H₂≥15 μm, this application further improves the impact resistance of the second metal layer 112. By setting H₁+H₂≤120 μm, this application further reduces the loss of energy density of the secondary battery 100.

Referring to FIG. 4 to FIG. 6, in some embodiments, the first metal layer 111 includes a first wall 1111 and a first sidewall 1112 connected to the periphery of the first wall 1111. The positive electrode of the electrode assembly 20 may be electrically connected to either the first wall 1111 or the first sidewall 1112. The first sidewall 1112 may be perpendicular to or inclined to the first wall 1111, without being limited herein. The second metal layer 112 includes a second wall 1121 and a second sidewall 1122 connected to the periphery of the second wall 1121. The second wall 1121 covers a surface of the first wall 1111, the surface of the first wall 1111 being facing away from the accommodation cavity 101. The second sidewall 1122 covers a surface of the first sidewall 1112, the surface of the first sidewall 1112 being facing away from the accommodation cavity 101. The second sidewall 1122 may be perpendicular to or inclined to the second wall 1121, without being limited herein. The second casing 12 includes a third wall 121 and a third sidewall 122 connected to the periphery of the third wall 121. The negative electrode of the electrode assembly 20 may be electrically connected to the third wall 121 or the third sidewall 122. The third sidewall 122 may be perpendicular to or inclined to the third wall 121, without being limited herein. Along the thickness direction of the electrode assembly 20, the first wall 1111 and the second wall 1121 are disposed facing the third wall 121, and the first sidewall 1112 and the second sidewall 1122 are disposed facing the third sidewall 122 and at a clearance from the third sidewall.

Referring to FIG. 4 to FIG. 6, the electrode assembly 20 includes a positive electrode plate 21, a negative electrode plate 22, and a separator 23. The positive electrode plate 21 is electrically connected to the first metal layer 111, and the negative electrode plate 22 is electrically connected to the second casing 12. The separator 23 separates the positive electrode plate 21 from the negative electrode plate 22. The separator 23 is an insulating film material such as polyethylene film, polypropylene film, polyester film, or polyimide film.

Referring to FIG. 4 to FIG. 6, in some embodiments, the electrode assembly 20 assumes a stacked structure, in which a plurality of positive electrode plates 21 and a plurality of negative electrode plates 22 are alternately stacked up, and the separator 23 is disposed between any adjacent positive electrode plate 21 and negative electrode plate 22. In some embodiments, the electrode assembly 20 is a stacked structure, in which one of the positive electrode plate 21 or the negative electrode plate 22 is continuously folded in a Z-shape, the other is disposed between any two adjacent Z-shaped folded layers, and the separator 23 is disposed between any adjacent positive electrode plate 21 and negative electrode plate 22. In some embodiments, the electrode assembly 20 is a jelly-roll structure, in which a single positive electrode plate 21 and a single negative electrode plate 22 are stacked and then wound together, and the separator 23 is disposed between the positive electrode plate 21 and the negative electrode plate 22.

In some embodiments, the positive electrode plate 21 includes a positive current collector and a positive active material layer. The positive active material layer is disposed on two surfaces of the positive current collector, the two surfaces being opposite to each other along the thickness direction of the current collector. The first metal layer 111 is electrically connected to the positive current collector. In some embodiments, the positive current collector is provided with a blank foil region. The first metal layer 111 is connected to the blank foil region of the positive current collector. For example, the first wall 1111 is directly connected to the blank foil region of the positive current collector. For another example, the first wall 1111 is indirectly connected to the blank foil region of the positive current collector by a first conductive piece (not shown in the figure). The first conductive piece includes, but is not limited to, a conductive protrusion or metal spring or a conductive adhesive. The conductive protrusion may be formed by laser-texturing the first wall 1111. In some embodiments, the positive current collector is provided with a positive tab 40. The positive current collector and the first metal layer 111 are electrically connected to the positive tab 40. For example, the positive current collector and the first sidewall 1112 are electrically connected to the positive tab 40. When there are a plurality of positive tabs 40, the plurality of positive tabs 40 may be stacked and then converged to form a positive tab bundle, and then the positive tab bundle is welded to the first metal layer 111.

In some embodiments, the positive current collector may be made of a material including at least one of aluminum, nickel, tantalum, or titanium. In some embodiments, both the positive tab 40 and the positive current collector are made of aluminum foil, and the first metal layer 111 is made of a material including aluminum. This further reduces the potential difference between the first casing 11 and the positive electrode of the electrode assembly 20, and further reduces the probability of electrochemical corrosion of the first casing 11.

In some embodiments, the negative electrode plate 22 includes a negative current collector and a negative active material layer. The negative active material layer is disposed on two surfaces of the negative current collector, the two surfaces being opposite to each other along the thickness direction of the current collector. The second casing 12 is electrically connected to the negative current collector. In some embodiments, the negative current collector is provided with a blank foil region. The third wall 121 of the second casing 12 is connected to the blank foil region of the negative current collector. For example, the third wall 121 is directly connected to the blank foil region of the negative current collector. For another example, the third wall 121 is indirectly connected to the blank foil region of the negative current collector by a second conductive piece (not shown in the figure). The second conductive piece includes, but is not limited to, a conductive protrusion or metal spring or a conductive adhesive. In some embodiments, the negative current collector is provided with a negative tab 50. The negative current collector and the second casing 12 are electrically connected to the negative tab 50. When there are a plurality of negative tabs 50, the plurality of negative tabs 50 may be stacked and then converged to form a negative tab bundle, and then the negative tab bundle is welded to the second casing 12.

In some embodiments, the negative current collector may be made of a material including at least one of copper, nickel, tantalum, or titanium, and the second casing 12 is made of stainless steel.

Referring to FIG. 4 to FIG. 6, in some embodiments, the sealing element 30 includes a filler portion 301 configured to fill the clearance between the first sidewall 1112/second sidewall 1122 and the third sidewall 122. The filler portion 301 is an insulator. The filler portion 301 that fills the clearance increases sealing interfaces between the sealing element 30 and the first casing 11 and the second casing 12, and improves hermeticity of the secondary battery 100. Further, the filler portion 301 that fills the clearance also facilitates insulation of the first casing 11 and the second casing 12.

Referring to FIG. 4, in some embodiments, the filler portion 301 covers at least a surface of the second sidewall 1122, the surface facing the clearance. When the second metal layer 112 is made of a relatively hard metal and the first metal layer 111 is made of a less hard metal, the second metal layer 112 and the first metal layer 111 are made of different metal materials. By leaving the filler portion 301 to cover the clearance-facing surface of the second sidewall 1122, this application reduces the probability of electrochemical corrosion of the first casing 11 caused by a potential difference generated when the first metal layer 111 and the second metal layer 112 are in simultaneous contact with the electrolyte solution. In some embodiments, the filler portion 301 also covers the clearance-facing surface of the first sidewall 1112 to reduce the probability that the first metal layer 111 and the second metal layer 112 are in simultaneous contact with the electrolyte solution in the case that the clearance-facing surface of the second sidewall 1122 is exposed after the filler portion 301 is corroded by the electrolyte solution.

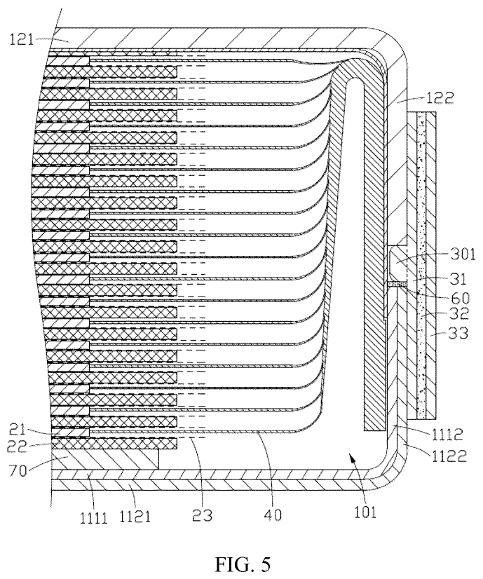

Referring to FIG. 5, in some embodiments, a protective layer 60 is provided on a surface of the first sidewall 1112 facing the clearance and on the surface of the second sidewall 1122 facing the clearance. The filler portion 301 is disposed between the third sidewall 122 and the protective layer 60. The protective layer 60 may be a polymer coating (such as a polytetrafluoroethylene coating, a polyvinylidene fluoride coating, or an epoxy resin coating) or a ceramic coating (such as an aluminum oxide coating, a zirconium oxide coating, or a silicone coating) or the like. The protective layer 60 is made of a material including at least one of polytetrafluoroethylene, polyvinylidene fluoride, epoxy resin, aluminum oxide, zirconium oxide, or silicone. By making the protective layer 60 include the above material and disposing the protective layer on the clearance-facing surfaces of the first sidewall 1112 and the second sidewall 1122, this application reduces the probability that the electrolyte solution erodes the sealing interface between the filler portion 301 and the first metal layer 111 and the second metal layer 112. This further reduces the probability of electrochemical corrosion of the first casing 11 caused by a potential difference generated when the first metal layer 111 and the second metal layer 112 are in simultaneous contact with the electrolyte solution.

In some embodiments, along the assembling direction of the first casing 11 and the second casing 12, the thickness of the protective layer 60 is 2 μm to 500 μm. Preferably, the thickness of the protective layer 60 is 5 μm to 200 μm. This prevents the thickness of the protective layer 60 from being excessively small, and improves the ability of the protective layer 60 to resist electrolyte erosion. This also prevents the thickness of the protective layer 60 from being excessively large, and reduces the energy density loss of the secondary battery 100.

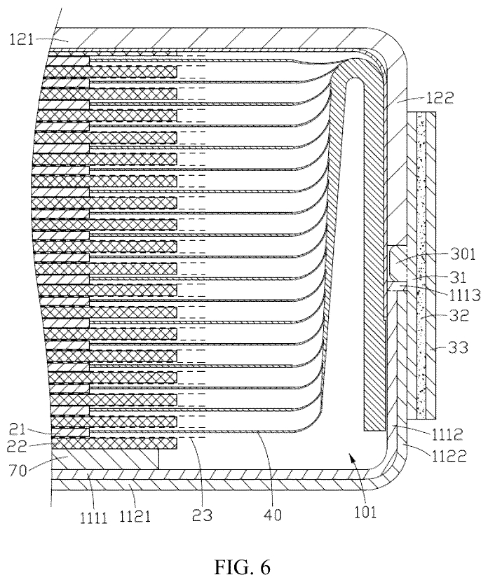

Referring to FIG. 6, in some embodiments, the first metal layer 111 includes an extension portion 1113. The extension portion 1113 is disposed at an end portion of the first sidewall 1112, the end portion of the first sidewall 1112 facing the clearance. The filler portion 301 is disposed between the third sidewall 122 and the extension portion 1113. The extension portion 1113 covers a surface of the second sidewall 1122, the surface facing the clearance. In a comparative practice, the sealing interface between the first sidewall 1112 and the filler portion 301 is used together with the sealing interface between the second sidewall 1122 and the filler portion 301 to serve as a sealing interface between the first casing 11 and the filler portion 301, and therefore, a step difference between the first sidewall 1112 and the second sidewall 1122 is prone to form along the assembling direction of the first casing 11 and the second casing 12. In this case, the sealing interface between the first casing 11 and the filler portion 301 is prone to be uneven. In contrast, by leaving the extension portion 1113 of the first metal layer 111 to cover the clearance-facing surface of the second sidewall 1122, this application causes the sealing interface between the extension portion 1113 and the filler portion 301 to become a sealing interface between the first casing 11 and the filler portion 301. This conveniently gives rise to a smoother sealing interface between the first casing 11 and the filler portion 301, makes the sealing interface less prone to electrolyte corrosion, and improves the hermeticity of the secondary battery 100. In addition, the extension portion 1113 can effectively isolate the clearance-facing surface of the second sidewall 1122 from the electrolyte solution, and reduce the probability of electrochemical corrosion of the first casing 11 caused by a potential difference generated when the first metal layer 111 and the second metal layer 112 are in simultaneous contact with the electrolyte solution.

Referring to FIG. 4 to FIG. 6, in some embodiments, the sealing element 30 includes a first adhesive layer 31. The first adhesive layer 31 is affixed to the outer periphery of the second sidewall 1122 and the third sidewall 122. The filler portion 301 is connected to the first adhesive layer 31. The adhesion of the first adhesive layer 31 to the second sidewall 1122 and the third sidewall 122 improves the stability of the bond between the sealing element 30 and the casing 10.

In some embodiments, the filler portion 301 is integrally formed with the first adhesive layer 31. The filler portion 301 may be directly formed by a part of the first adhesive layer 31 that is cooled after melting and entering the clearance between the first sidewall 1112 plus the second sidewall 1122 and the third sidewall 122. This simplifies the assembling process of the secondary battery 100, and streamlines the manufacturing process of the secondary battery 100. Further, by being integrally formed with the first adhesive layer 31, the filler portion 301 can thoroughly fit the clearance between the first sidewall 1112 plus the second sidewall 1122 and the third sidewall 122, thereby improving the hermeticity of the sealing element 30 for the first casing 11 and the second casing 12. In other embodiments, the filler portion 301 is disposed separate from the first adhesive layer 31.

In some embodiments, the first adhesive layer 31 is capable of melting or losing adhesion upon heating, and forms a part of a pressure-relief channel in communication with the accommodation cavity 101. When the secondary battery 100 is thermally runaway, the first adhesive layer 31 melts or loses adhesion to promptly relieve pressure in the accommodation cavity 101, thereby improving the safety of the secondary battery 100.

In some embodiments, the melting point of the first adhesive layer 31 is 95 °C to 130 °C. For example, the melting point of the first adhesive layer 31 is 95 °C, 100 °C, 110 °C, 130 °C, or a range formed by any two thereof or a value falling within a range formed by any two thereof. By setting the melting point of the first adhesive layer 31 to be 95 °C to 130 °C, this application reduces the probability of premature melting or adhesion loss of the first adhesive layer 31 before thermal runaway of the secondary battery 100, thereby maintaining good sealing effect of the sealing element 30 on the casing 10. In addition, this setting ensures that, in the case of thermal runaway of the secondary battery 100, the first adhesive layer 31 promptly melts or loses adhesion to relieve pressure in the accommodation cavity 101, thereby improving the safety of the secondary battery 100. Understandably, in the case that the filler portion 301 is integrally formed with the first adhesive layer 31, when the filler portion 301 is directly formed by a part of the first adhesive layer 31 that is cooled after melting and entering the clearance between the first sidewall 1112 plus the second sidewall 1122 and the third sidewall 122, the melting point of the filler portion 301 is substantially identical to the melting point of the first adhesive layer 31. When the secondary battery 100 is thermally runaway, the above arrangement makes it convenient for the first adhesive layer 31 and the filler portion 301 to promptly melt or lose adhesion to relieve pressure in the accommodation cavity 101, thereby reducing the risk of contact shorting between the first casing 11 and the second casing 12.

In some embodiments, the first adhesive layer 31 is made of a material including an electrolyte-resistant polymer. The polymer of the first adhesive layer 31 includes at least one of polyolefin, fluororubber, or polyurethane. The polyolefin may include polypropylene, polyethylene, and the like. Accordingly, the first adhesive layer 31 exhibits relatively high resistance to electrolyte corrosion. In some embodiments, the first adhesive layer 31 includes a single-layer or multi-layer polymer.

Referring to FIG. 4 to FIG. 6, in some embodiments, the sealing element 30 includes a water-blocking layer 32. The water-blocking layer 32 is disposed on the first adhesive layer 31 on a side facing away from the casing 10. The water-blocking layer 32 is made of a material including at least one of steel, aluminum, nickel, silver, copper, or an alloy thereof. By using the water-blocking layer 32 made of the above materials, this application makes the water-blocking layer 32 more capable of blocking water than the first adhesive layer 31, thereby improving the ability of the sealing element 30 to seal the first casing 11 and the second casing 12. The water-blocking layer 32 is insulated from the second sidewall 1122 and the third sidewall 122 by the first adhesive layer 31. In some embodiments, the water-blocking layer 32 is a single-layer or multi-layer structure. For example, the multi-layer structure may be a steel layer plus an aluminum layer or a nickel layer plus a copper layer.

Referring to FIG. 4 to FIG. 6, in some embodiments, the sealing element 30 includes a second adhesive layer 33. The second adhesive layer 33 is disposed on the water-blocking layer 32 on a side facing away from the first adhesive layer 31. The second adhesive layer 33 can protect the water-blocking layer 32, thereby reducing the risk of breakage or failure of the water-blocking layer 32.

In some embodiments, the melting point of the second adhesive layer 33 is higher than that of the first adhesive layer 31. In some embodiments, the melting point difference between the second adhesive layer 33 and the first adhesive layer 31 is 10 °C or more.

In some embodiments, the melting point of the second adhesive layer 33 is 140 °C to 500 °C. For example, the melting point of the second adhesive layer 33 is 140 °C, 160 °C, 200 °C, 250 °C, 300 °C, 500 °C, or a value falling within a range formed by any two thereof.

In some embodiments, the second adhesive layer 33 is made of a material including an electrolyte-resistant polymer. The polymer of the second adhesive layer 33 includes at least one of polyolefin, fluoropolymer, polyether ether ketone, fluororubber, or polyurethane. The polyolefin may include polypropylene, polyethylene, and the like. The fluoropolymer may be polytetrafluoroethylene or the like. Accordingly, the second adhesive layer 33 exhibits relatively high resistance to electrolyte corrosion. In some embodiments, the second adhesive layer 33 includes a single-layer or multi-layer polymer.

Understandably, when the sealing element 30 includes the first adhesive layer 31, the water-blocking layer 32, and the second adhesive layer 33 concurrently, the first adhesive layer 31 and the second adhesive layer 33 are disposed on two sides of the water-blocking layer 32 respectively along the thickness direction of the water-blocking layer 32. In some embodiments, the first adhesive layer 31 is adhesively fixed to the water-blocking layer 32, and the second adhesive layer 33 is adhesively fixed to the water-blocking layer 32, such that the first adhesive layer 31, the water-blocking layer 32, and the second adhesive layer 33 are combined into a whole. In some embodiments, the first adhesive layer 31 is fixed to the water-blocking layer 32 by hot pressing, and the second adhesive layer 33 is fixed to the water-blocking layer 32 by hot pressing, such that the first adhesive layer 31, the water-blocking layer 32, and the second adhesive layer 33 are combined into a whole. During the long-term use of the secondary battery 100, the above arrangement is beneficial to maintaining the ability of the sealing element 30 to seal the first casing 11 and the second casing 12.

In some embodiments, along the thickness direction of the sealing element 30, the thickness of the first adhesive layer 31 is d₁, the thickness of the water-blocking layer 32 is d₂, and the thickness of the second adhesive layer 33 is d₃, wherein 7 μm≤d₁≤500 μm, 7 μm≤d₂≤250 μm, and 6 μm≤d₃≤500 μm. For example, d₁ is 7 μm, 10 μm, 20 μm, 50 μm, 100 μm, 200 μm, 500 μm, or a value falling within a range formed by any two thereof; d₂ is 7 μm, 10 μm, 20 μm, 50 μm, 100 μm, 150 μm, 250 μm, or a value falling within a range formed by any two thereof; and d₃ is 6 μm, 8 μm, 20 μm, 50 μm, 100 μm, 200 μm, 500 μm, or a value falling within a range formed by any two thereof. By setting 7 μm ≤d₁, 7 μm≤d₂, and 6 μm≤d₃, this application prevents the first adhesive layer 31, the water-blocking layer 32, and the second adhesive layer 33 from being excessively thin, thereby reducing the risk of failure of the first adhesive layer 31 after being corroded by the electrolyte solution, and reducing the risk that the water-blocking layer 32 fails due to breakage or the water-blocking layer 32 fails due to erosion after the second adhesive layer 33 is broken by a drop of the secondary battery 100. By setting d₁≤500 μm, d₂≤250 μm, and d₃≤500 μm, this application prevents the first adhesive layer 31, the water-blocking layer 32, and the second adhesive layer 33 from being excessively thick, thereby increasing the energy density of the secondary battery 100.

In some embodiments, 10 μm≤d₁≤200 μm, 10 μm≤d₂≤150 μm, and 8 μm≤d₃≤200 μm. By setting 10 μm≤d₁, 10 μm≤d₂, and 8 μm≤d₃, this application makes the first adhesive layer 31, the water-blocking layer 32, and the second adhesive layer 33 thicker, thereby further reducing the risk of failure of the first adhesive layer 31 after being corroded by the electrolyte solution, and further reducing the risk that the water-blocking layer 32 fails due to breakage or the water-blocking layer 32 fails due to erosion after the second adhesive layer 33 is broken by a drop of the secondary battery 100. By setting d₁≤200 μm, d₂ ≤150μm, and d₃≤200 μm, this application further increases the energy density of the secondary battery 100 while ensuring that the thickness of the first adhesive layer 31 is basically sufficient to prevent failure caused by electrolyte corrosion, and that the thickness of the second adhesive layer 33 is sufficient to survive most drop scenarios, and that the thickness of the water-blocking layer 32 is basically sufficient to prevent failure caused by breakage or erosion.

In some embodiments, the thickness of the first adhesive layer 31 may be uniform or non-uniform. In some embodiments, the thickness of the water-blocking layer 32 may be uniform or non-uniform. In some embodiments, the thickness of the second adhesive layer 33 may be uniform or non-uniform. In some embodiments, the thickness of the sealing element 30 may be uniform or non-uniform, and the thickness of the sealing element 30 is equal to the sum of the thicknesses of the first adhesive layer 31, the water-blocking layer 32, and the second adhesive layer 33.

Referring to FIG. 4 to FIG. 6, in some embodiments, the secondary battery 100 further includes a fixing piece 70. The fixing piece 70 is configured to affix the casing 10 to the electrode assembly 20. This reduces the risk that the first casing 11 and/or the second casing 12 is detached from the sealing element 30 due to wobbling of the electrode assembly 20 in the accommodation cavity 101. In some embodiments, the fixing piece 70 is disposed between the casing 10 and the electrode assembly 20 along the thickness direction of the electrode assembly 20. For example, the fixing piece 70 is disposed between the first metal layer 111 and the electrode assembly 20. In some embodiments, the fixing piece 70 is a hot-melt adhesive.

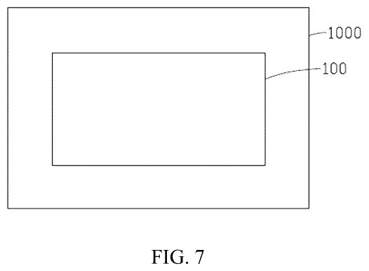

Referring to FIG. 7, an embodiment of this application provides an electrical device 1000, including the above-mentioned secondary battery 100. The electrolyte solution in the secondary battery 100 is not prone to leakage, thereby prolonging the lifespan of the electrical device 1000. The electrical device 1000 includes, but is not limited to, electronic devices such as an e-book player, a mobile phone, a fax machine, a photocopier, a printer, a headphone, a video recorder, an LCD TV, an audio recorder, a radio, a camera, a tablet, and a laptop.

In addition, a person of ordinary skill in the art understands that the foregoing embodiments are merely intended to illustrate this application, but not to limit this application. Any and all appropriate modifications and changes made to the embodiments without departing from the essence of this application still fall within the protection scope of this application.

What is claimed is:

1. A secondary battery, comprising:
a casing, comprising a first casing and a second casing that are insulated from each other, wherein the first casing and the second casing together form an accommodation cavity, and the accommodation cavity is filled with an electrolyte solution; the first casing and the second casing are disposed facing each other, with a clearance in between; the first casing comprises a first metal layer and a second metal layer; the second metal layer covers a surface of the first metal layer, the surface of the first metal layer being facing away from the accommodation cavity; and a hardness of the second casing and a hardness of the second metal layer are greater than a hardness of the first metal layer;
an electrode assembly disposed in the accommodation cavity, wherein a positive electrode of the electrode assembly is electrically connected to the first metal layer, and a negative electrode of the electrode assembly is electrically connected to the second casing; and
a sealing element, disposed around an outer periphery of the first casing and the second casing, and sealing the clearance.

2. The secondary battery according to claim 1, wherein the first metal layer is made of a material comprising at least one of aluminum, zinc, or magnesium; and the second casing and the second metal layer each are made of a material comprising at least one of iron, nickel, chromium, or titanium.

3. The secondary battery according to claim 2, wherein the electrode assembly comprises a positive electrode plate; the positive electrode plate comprises a positive current collector and a positive active material layer; the positive active material layer is disposed on two surfaces of the positive current collector, the two surfaces being opposite to each other along a thickness direction of the current collector; the positive current collector is provided with a positive tab;
the positive current collector and the first metal layer are electrically connected to the positive tab; both the positive tab and the positive current collector are made of aluminum foil; and the first metal layer is made of a material comprising aluminum.

4. The secondary battery according to claim 2, wherein along a wall thickness direction of the first casing, a thickness of the first metal layer is H₁, and a thickness of the second metal layer is H₂, wherein 16 μm≤H₁+H₂≤150 μm, H₁≥6 μm, and H₂≥10 μm.

5. The secondary battery according to claim 4, wherein 23 μm≤H₁+H₂≤120 μm, H₁≥8 μm, and H₂≥15 μm.

6. The secondary battery according to claim 1, wherein the first metal layer comprises a first wall and a first sidewall connected to a periphery of the first wall, the second metal layer comprises a second wall and a second sidewall connected to a periphery of the second wall, the second casing comprises a third wall and a third sidewall connected to a periphery of the third wall, the first wall and the second wall are disposed facing the third wall, the first sidewall and the second sidewall are disposed facing the third sidewall along a thickness direction of the electrode assembly and at the clearance from the third sidewall, and the sealing element comprises a filler portion filling the clearance.

7. The secondary battery according to claim 6, wherein the filler portion covers at least a surface of the second sidewall facing the clearance.

8. The secondary battery according to claim 7, wherein a protective layer is provided on a surface of the first sidewall facing the clearance and on the surface of the second sidewall facing the clearance; the filler portion is disposed between the third sidewall and the protective layer; the protective layer is made of a material comprising at least one of polytetrafluoroethylene, polyvinylidene fluoride, epoxy resin, aluminum oxide, zirconium oxide, or silicone.

9. The secondary battery according to claim 6, wherein the first metal layer comprises an extension portion; the extension portion is disposed at an end portion of the first sidewall, the end portion of the first sidewall facing the clearance; the filler portion is disposed between the third sidewall and the extension portion; and the extension portion covers a surface of the second sidewall facing the clearance.

10. The secondary battery according to claim 1, wherein Brinell hardness of the first metal layer is 10 HB to 60 HB, Brinell hardness of the second casing is 110 HB to 320 HB, and Brinell hardness of the second metal layer is 110 HB to 320 HB.

11. The secondary battery according to claim 1, wherein a yield strength of the second metal layer is greater than or equal to 150 MPa.

12. An electrical device, comprising a secondary battery, and the secondary battery comprises:
a casing, comprising a first casing and a second casing that are insulated from each other, wherein the first casing and the second casing together form an accommodation cavity, and the accommodation cavity is filled with an electrolyte solution; the first casing and the second casing are disposed facing each other, with a clearance in between; the first casing comprises a first metal layer and a second metal layer; the second metal layer covers a surface of the first metal layer, the surface of the first metal layer being facing away from the accommodation cavity; and a hardness of the second casing and a hardness of the second metal layer are greater than a hardness of the first metal layer;
an electrode assembly disposed in the accommodation cavity, wherein a positive electrode of the electrode assembly is electrically connected to the first metal layer, and a negative electrode of the electrode assembly is electrically connected to the second casing; and
a sealing element, disposed around an outer periphery of the first casing and the second casing, and sealing the clearance.

13. The electrical device according to claim 12, wherein the first metal layer is made of a material comprising at least one of aluminum, zinc, or magnesium; and the second casing and the second metal layer each are made of a material comprising at least one of iron, nickel, chromium, or titanium.

14. The electrical device according to claim 13, wherein the electrode assembly comprises a positive electrode plate; the positive electrode plate comprises a positive current collector and a positive active material layer; the positive active material layer is disposed on two surfaces of the positive current collector, the two surfaces being opposite to each other along a thickness direction of the current collector; the positive current collector is provided with a positive tab;
the positive current collector and the first metal layer are electrically connected to the positive tab; both the positive tab and the positive current collector are made of aluminum foil; and the first metal layer is made of a material comprising aluminum.

15. The electrical device according to claim 13, wherein along a wall thickness direction of the first casing, a thickness of the first metal layer is H1, and a thickness of the second metal layer is H 2, wherein 16 μm≤H1+H2≤150 μm, H1≥6 μm, and H2≥10 μm.

16. The electrical device according to claim 15, wherein 23 μm≤H1+H2≤120 μm, H1≥8 μm, and H2≥15 μm.

17. The electrical device according to claim 12, wherein the first metal layer comprises a first wall and a first sidewall connected to a periphery of the first wall, the second metal layer comprises a second wall and a second sidewall connected to a periphery of the second wall, the second casing comprises a third wall and a third sidewall connected to a periphery of the third wall, the first wall and the second wall are disposed facing the third wall, the first sidewall and the second sidewall are disposed facing the third sidewall along a thickness direction of the electrode assembly and at a clearance from the third sidewall, and the sealing element comprises a filler portion filling the clearance.

18. The electrical device according to claim 17, wherein the filler portion covers at least a surface of the second sidewall facing the clearance;
and/or, a protective layer is provided on a surface of the first sidewall facing the clearance and on the surface of the second sidewall facing the clearance; the filler portion is disposed between the third sidewall and the protective layer; the protective layer is made of a material comprising at least one of polytetrafluoroethylene, polyvinylidene fluoride, epoxy resin, aluminum oxide, zirconium oxide, or silicone.

19. The electrical device according to claim 17, wherein the first metal layer comprises an extension portion; the extension portion is disposed at an end portion of the first sidewall, the end portion of the first sidewall facing the clearance; the filler portion is disposed between the third sidewall and the extension portion; and the extension portion covers a surface of the second sidewall facing the clearance.

20. The electrical device according to claim 12, wherein Brinell hardness of the first metal layer is 10 HB to 60 HB, Brinell hardness of the second casing is 110 HB to 320 HB, and Brinell hardness of the second metal layer is 110 HB to 320 HB;
and/or, a yield strength of the second metal layer is greater than or equal to 150 MPa.
